(19) United States
(12) Patent Application Publication
(10) Pub. No.: US 2006/0145841 A1
(43) Pub. Date: Jul. 6, 2006

(54) Alarm system comprising an alarm mobile terminal and an alarm server

(75) Inventors: Veronique Daurensan, Antony (FR); Philippe Licata, Guibeville (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/319,505

(22) Filed: Dec. 29, 2005

(30) Foreign Application Priority Data
Dec. 31, 2004 (FR) 0453279

(51) Int. Cl. G08B 1/08

(52) U.S. Cl. 340/539.22; 340/870.01

(57) ABSTRACT

Using a mobile terminal (2) while moving, a user has a voice conversation with a security terminal (1) provided by a security service provider. This conversation creates a situation in which it is possible to immediately send an alarm if an emergency occurs, thus repelling assaulters or abductors lurking near the user. The mobile terminal (2) is provided with GPS or the like, and position information of the mobile terminal (2) is sent to the security terminal (1). &lt;??&gt;The security service provider takes advertisements from advertisers selling goods or services, and prepares conversation scenarios that are the content of the conversations for automatic response based on those advertisements. The security terminal (1) firstly provides the user with a voice conversation partner proxy service based on the conversation scenarios and secondly detects emergencies by detecting emergency messages from the mobile terminal (2) or detecting the interruption of the conversation. After that, the security service provider can restrict the danger to the user to a minimum by undertaking emergency measures such as dispatching someone to the location where the mobile terminal (2) is located.

### CROSS-REFERENCE TO RELATED APPLICATIONS

This application is based on French Patent Application No. 0453279 filed Dec. 31, 2004, the disclosure of which is hereby incorporated by reference thereto in its entirety, and the priority of which is hereby claimed under 35 U.S.C. §119.

### BACKGROUND OF THE INVENTION

1. Field of the Invention

The invention relates to alarm systems, and more particularly alarm systems that send alarm messages incorporating at least one picture. In an alarm system, the user of a mobile terminal uses his mobile terminal to send an alarm message to an emergency service via a server of a telecommunication network. The mobile terminal is preferably a mobile telephone, but could also be some other device able to send alarm messages to a server. In a problem or danger situation, the user takes at least one picture of the problem or danger situation using a camera incorporated in his mobile terminal, incorporates it into an alarm message that he sends via his mobile terminal to a server, which forwards it to an appropriate emergency service, i.e. an agency able to process or manage the incident that is the source of the problem or danger, for example the emergency service specializing in processing the type of incident concerned and nearest the presumed location of the incident. The procedure for sending alarm messages is sufficiently fast and efficient to enable the emergency service selected by the server to process or manage the incident in a sufficiently short time to improve substantially the processing or management of the incident compared to the situation if no alarm message had been sent. The advantage of an alarm message incorporating at least one picture is fundamental since it enables instantaneous sending to an emergency service of a large amount of information that the emergency service can assimilate quickly, whereas it would have taken a long time for the user to provide an emergency service with the same amount of information by means of a voice message alone, for example, the user often having insufficient time for this because he is faced with a problem or danger situation. This type of alarm system can help to improve greatly the safety of users or at least their feeling of safety.

2. Description of the Prior Art A prior art alarm system described in international patent application WO 0215143 or US patent application 2003/0137422 enables the user of a mobile terminal to send an alarm message containing at least one picture. However, it has the disadvantage, stemming from how the user uses it, either of too high a failure rate or of too many false alarms. Another prior art alarm system is disclosed in the Japanese patent application JP 2002237908.

Reality shows that problem or danger situations are often only potential problem or danger situations at the outset, and become actual problem or danger situations that need to be processed or managed by an emergency service only afterwards. The user is confronted by the following dilemma: either he decides to send an alarm message during a first time period in which the incident observed represents only a potential problem or danger that has not yet become concrete, in which case, if the problem or the danger remains a potential one and does not become concrete, the user sending the alarm message would constitute a false alarm alerting an emergency service and leading to processing by the emergency service of an incident that in the end is benign and requires no processing or management. Such false alarms are costly and cause emergency services to waste their time and energy, which is undesirable given the difficult missions with which they are entrusted. The alternative is for the user to decide to send an alarm message during a second time period when the incident he has noted represents a previously potential problem or danger that has already become concrete, in which case it will unfortunately often already be too late in that the user will no longer have time or even the opportunity of using the alarm system under the appropriate conditions necessary for it to be efficacious. Irreparable harm may then ensue that could have been avoided or reduced if the user had sent the alarm message during the first time period. This reduces the efficacy of the alarm system and the confidence that users may legitimately have in it.

Consider, for example, the situation of a woman passenger alone in the metro late at night at the end of the line. A gang of persons enters her carriage at a station. Either the passenger films them discreetly and sends an alarm message, which can be a nuisance if the gang of sinister looking persons has only peaceable intentions and does not bother the passenger. Alternatively, the passenger delays and is then assaulted, when it is too late for her to send an alarm message, either because her assailants prevent her doing so or because they have already stolen her mobile terminal. The passenger may be injured or raped and the description of her assailants may be vague, for example three persons of average height wearing jeans, etc., which will not facilitate the police investigation; the passenger might even be murdered, in which case the police would obtain even less information from the victim.

The invention proposes an alarm system offering the user of a mobile terminal able to send an alarm message including a picture the possibility of a less stressful situation partway between alerting an emergency service and doing nothing, namely taking steps to be in a favorable situation for alerting the emergency service at the time of an actual and clearly demonstrated need to do so. To this end, the alarm system offers the user the possibility of storing an alarm message in a buffer memory area without sending it directly to the emergency service, which message may subsequently be sent virtually instantaneously, for example on the instructions of the user. Thus the user can save an alarm message, the content whereof may be very rich as it incorporates at least one picture, before it is too late to save the message. In the case of an alarm message of leaner content, for example a voice message, the benefit of the buffer memory area would be less or even practically non-existent. The buffer memory area is external to the mobile terminal, which makes it secure by reducing the effectiveness of malevolent action intended to erase a saved message, for example destruction of the mobile terminal.

Consider again the example of the woman passenger in the metro. She discreetly films the gang of sinister looking persons when they enter the carriage and the wall of the station bearing its name, for example by pretending to consult her mobile terminal. For example, she then keeps her finger on an alarm key the mere pressing of which will send to an emergency service the alarm message that is ready to send. Either the persons do not bother her, in which case when safely home the passenger has only to delete the alarm message stored in the buffer memory area, or the persons accost and bother her, thereby revealing their malevolent intentions, at which point she has various options. She can press the alarm key so that the police can send a rapid response team to the next station before the attack has led to irreparable harm such as a serious injury or death; even if the alarm key is not pressed, if she is actually attacked and seriously injured, or if her handbag is stolen, she will still hove a picture of the assailants showing their faces to offer afterwards to the police, even if the assailants have stolen her mobile terminal, because the buffer memory area is external to the mobile terminal, which greatly increases the chances of the police finding the assailants. Even if the passenger is killed, the police investigators can obtain the alarm message stored in the buffer memory area and therefore follow up an interesting lead.

The invention concerns an alarm system and a mobile terminal and a server of the alarm system that are specifically adapted to enable correct operation of the alarm system or more advantageous, be it optional, operation of the alarm system.

### SUMMARY OF THE INVENTION

The invention provides an alarm system comprising a mobile terminal comprising a camera able to take at least one picture and a server interface able to send at least one alarm message including at least one picture, at least one emergency service able to process an alarm message, a server able to send an alarm message to an emergency service and a buffer memory area external to the mobile terminal able to store an alarm message. The mobile terminal further comprises a user interface enabling the user of the mobile terminal to indicate to the server that an alarm message should be stored in the buffer memory area without being previously or simultaneously transmitted for processing to an emergency service. Strictly speaking, the alarm message could be sent to a part of an emergency service whose only function is to store it, not to process it; thus storing the message will not lead to alerting of the emergency service and will not instigate processing by the part of the emergency service responsible for processing alarm messages by reacting appropriately, its reactions usually involving active participation by at least some of the personnel of the emergency service.

The invention more specifically provides an alarm system comprising a mobile terminal comprising a camera able to take at least one picture, a server interface able to send at least one alarm message including at least one picture taken by the camera and at least one emergency service able to process the alarm message; a server able to send the alarm message to the emergency service or to one of the emergency services; and a buffer memory area external to the mobile terminal able to store the alarm message or at least one of the alarm messages. The mobile terminal further comprises a user interface enabling the user of the mobile terminal to indicate to the server that an alarm message must be stored in the buffer memory area without being previously or simultaneously transmitted to the emergency service or to one of the emergency services so that the user can initiate or prevent processing by the emergency service or by one of the emergency services of an alarm message stored in the buffer memory area.

The invention also provides an alarm mobile terminal comprising a camera able to take at least one picture, a server interface able to send a server at least one alarm message including at least one picture taken by the camera, a user interface enabling the user of the mobile terminal to indicate to a server that the alarm message must be stored in a buffer memory area external to the mobile terminal without previously or simultaneously being sent to an emergency service so that the user can initiate or prevent processing by an emergency service of an alarm message stored in the buffer memory area.

The invention further provides an alarm server for sending an emergency service an alarm message coming from a mobile terminal and including at least one picture, the server comprising a buffer memory area able to store the alarm message and a processing device able, at the request of a user of the mobile terminal, to store in the buffer memory area an alarm message coming from a mobile terminal without previously or simultaneously sending it to an emergency service for processing.

The invention will be better understood and other features and advantages will become apparent in the light of the following description and the appended drawing, which is provided by way of example.

### BRIEF DESCRIPTION OF THE DRAWING

FIG. 1 is a diagram of one embodiment of an alarm system of the invention.

### DETAILED DESCRIPTION OF THE PREFERRED EMBODIMENT

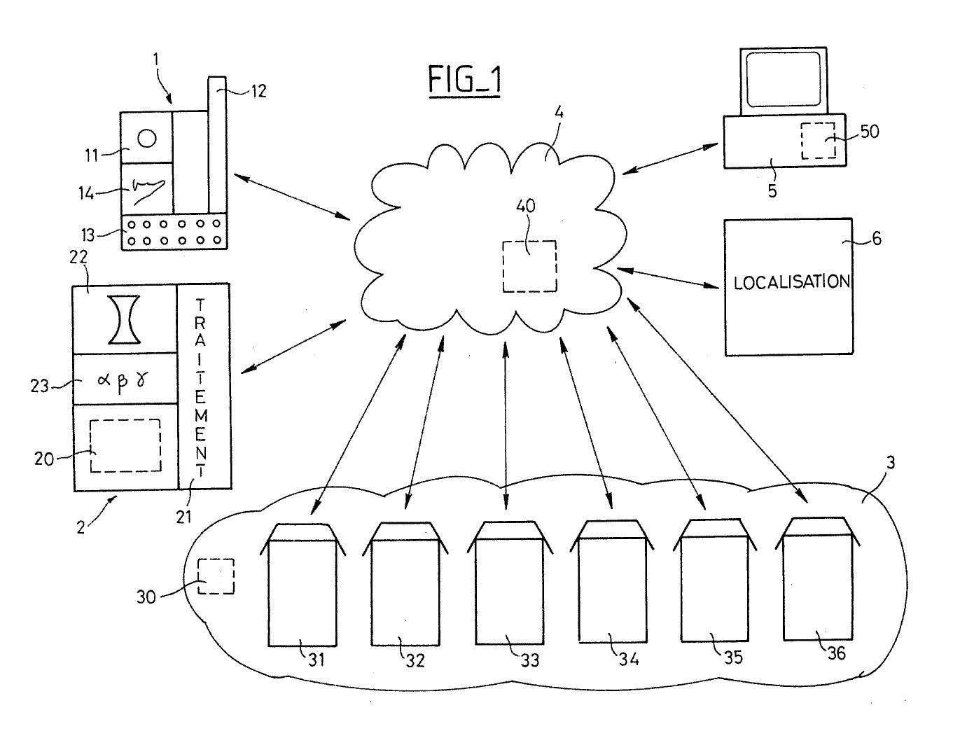

FIG. 1 is a diagram of one embodiment of an alarm system of the invention. The alarm system comprises a mobile terminal 1, a server 2, an emergency service network 3, a fixed personal computer 5 and a device 6 for locating the source of a call in the telecommunication network 4, all of the above communicating with each other via the telecommunication network 4. The mobile terminal 1 comprises a camera 11, a server interface 12, a user interface 13 and an electronic signature module 14. The server interface 12 is an antenna, for example. The user interface 13 comprises a keypad and/or a microphone, for example. The server 2 comprises a processing device 21, a timer module 22 and an encryption module 23. The emergency service network 3 comprises a plurality of emergency services, for example two police stations 31 and 32, two fire stations 33 and 34, and two hospitals 35 and 36. A buffer memory area external to the mobile terminal may be situated at various locations indicated in dashed outline, and could even be situated at more than one of these locations at a time. It may be a buffer memory area 20 in the server 2. It could even be a buffer memory area 30 in the emergency service network 3, but merely storing messages in the buffer memory area 30 would not alert the emergency services 31 to 36, which would not process the contents of the buffer memory area 30 unless some other event rendered the alarm message operative, in which case it would then be processed by at least one of the emergency services 31 to 36. It could be a buffer memory area 50 in the fixed personal computer 5 of the user of the mobile terminal, which has the advantage for the user of being less costly as it is located on the premises of the user. It could equally well be a buffer memory area 40 elsewhere in the telecommunication network 4.

There follows a preferred example of how the alarm system of the invention operates. In the event of potential problem or danger, the user of the mobile terminal 1 takes a photo or a video using the camera 11 incorporated into the mobile terminal 1. Using the user interface 13, the user incorporates the photo or video into an alarm message including his electronic signature supplied by the electronic signature module 14 and to be stored in a buffer memory area, for example the buffer memory area 20 in the server 2. The server interface 12 sends the alarm message to the server 2. The processing device 21 receives and recognizes the alarm message. However, it may be envisaged that certain alarm messages are transmitted directly to the emergency service by the server 2 without being processed by the server 2, or even being totally transparent for the server 2 and not even registered by the server 2, for example messages that are not intended to be stored in the buffer memory area but to be sent directly to the emergency service, because the user is in no doubt as to the real and effective nature of the danger. The alarm message is encrypted by the encryption module 23. The encrypted alarm message is stored in the buffer memory area 20. The timer module 22 starts a countdown as soon as the encrypted alarm message is placed in the buffer memory area 20. At the end of the countdown, if the user has not yet deleted the stored alarm message, which he can do from his fixed personal computer 5 or from his mobile terminal 1, the processing device 21 sends the alarm message either to the emergency service network 3, which will forward it to one of the emergency services 31 to 36, or (and preferably) directly to one of the emergency services 31 to 36 of the emergency service network 3. As a function of the content of the photo or the video, representing the type of incident, for example a fire, the processing device 21 of the server 2 opts to send it to one of the fire stations 33 or 34, the choice between the two fire stations 33 and 34 being based on a criterion of geographical proximity to the place from which the alarm message was sent, generally corresponding to the location of the incident giving rise to the alarm message. The location of the place from which the alarm message was sent is supplied to the server 2 via a location device 6. Once alerted, the emergency service, for example here the fire station 33, then processes or manages the incident giving rise to the alarm message; to this end, the fire station 33 may communicate with its response teams, or even with other emergency services, for example with a hospital 35 or 36 in the case of burn victims in the event of a fire.

Many examples other than a female metro passenger being attacked by a gang of sinister looking persons may be envisaged. All types of event of a problematic or dangerous nature may be envisaged where the user hesitates between giving an alarm and doing nothing. Events that may be envisaged include in particular other types of attack, accidents, equivocal situations, etc. More concrete examples are being a witness to a fight and providing information to the police in the event of the death of one of the protagonists, being caught in a fire in a building filled with smoke, in which the fire service, even before responding, can give the user advice (“a few yards to your right is a door leading to an emergency staircase” or “turn around, you are heading into a dead end”), providing simple first aid to an injured person with the assistance of nursing staff at the hospital (“put a cushion under his head” or “get him to drink some water”). Consider, for example, the situation of a user witnessing a fight between several persons in the street on returning home one evening. Is this a friendly scuffle between friends? Or is it a fight that may end badly in the death of one of the protagonists? If the user films the fight and sends the video in an alarm message, he may disturb the police station for nothing. If the user goes on his way and does nothing, he may be very upset to hear on the radio the next day that a person was killed in that street and that the police have no leads for tracking down the killer(s). In this case, storing the information in the buffer memory area preserves it and enables it to be used afterwards.

The alarm system of the invention offers a buffer memory area that is secure in that it is external to the mobile terminal, which offers a minimum degree of security. Depending on the type of situation that is the subject matter of the alarm message stored in the buffer memory area, this minimum degree of security may not be the optimum, and a greater degree of security of the buffer memory area may be preferred.

In a preferred embodiment, alarm messages stored in the buffer memory area can be deleted or modified from the mobile terminal only using a secret code known to the user of the mobile terminal. Security is increased, but is not yet the optimum because an assailant may force the user to reveal the secret code.

In another preferred embodiment, alarm messages stored in the buffer memory area cannot be deleted from the mobile terminal. Thus an assailant who has gained control over the mobile terminal and its user by force or by threats cannot delete the alarm message, which is out of harm's way of the assailant. In the situation of an attack on a user in the metro, regardless of the control acquired by the sinister looking persons over the user (threats, force), a photo showing their faces is stored out of their reach: this may dissuade them and prevent them from going beyond the point of no return, given the sure knowledge that they can be tracked down by the police. Alarm messages stored in the buffer memory area can advantageously not even be modified from the mobile terminal. Such messages could therefore, under certain conditions, even be used as evidence, in that such and such a photo was sent by such and such a mobile terminal from such and such a place at such and such a time.

Without regard to the above and subsequent embodiments, and in a manner that is entirely compatible with the above and subsequent embodiments, an alarm message stored in the buffer memory area could be deleted automatically if it is actually sent to an emergency service able to process and manage it. The alarm system may offer the user at least two methods that are not mutually exclusive of managing alarm messages stored in the buffer memory area.

In one method, the default option is for an alarm message stored in the buffer memory area not to be sent to an emergency service unless the user sends an instruction to the contrary. In the situation where the potential problem or danger becomes concrete, the user can instruct immediate sending of the stored alarm message to an emergency service for processing by that emergency service. To this end, the user interface of the mobile terminal preferably enables the user of the mobile terminal to indicate to the server that an alarm message stored in the buffer memory area must be sent to an emergency service.

In the other method, the default option is for an alarm message stored in the buffer memory area to be sent to an emergency service automatically after a time delay unless the user issues an instruction to the contrary, the user again being advantageously able to cause the alarm message to be sent to an emergency service ahead of time, i.e. before the end of the time delay. In the situation where the potential problem or danger disappears before becoming concrete, the user can instruct deletion of the alarm message stored in the buffer memory area, since it is now of no benefit, without the alarm message having been sent to an emergency service, which would have constituted a false alarm. To this end, the system comprises a time delay at the end of which messages stored in the buffer memory area are sent to an emergency service unless the user issues an instruction to the contrary and the user interface of the mobile terminal enables the user of the mobile terminal to indicate to the server that an alarm message stored in the buffer memory area must not be sent to an emergency service. In a preferred numerical example, the time delay is from 6 to 48 hours, for example 12 hours or 24 hours, to give the user time to delete the alarm message before it is sent to an emergency service, even if the user can no longer access it from the mobile terminal. A time delay with an instruction to confirm sending at the end of the time delay may also be envisaged.

In an embodiment meeting a requirement for a relatively high level of security, an alarm message stored in the buffer memory area may be deleted or modified from an element of the telecommunication network that is separate from the mobile terminal of the user and to which the user of the mobile terminal has access.

In an embodiment meeting the requirement for preserving evidence of an event, the user may delete an alarm message stored in the buffer memory area but not modify it. If only the server can modify an alarm message stored in the buffer memory area, the server could serve as an authority certifying the authenticity of the stored alarm message, i.e. the fact that such and such an alarm message with such and such a content was sent by such and such a mobile terminal from such and such a place at such and such a time.

The alarm message intended to be stored in the buffer memory area, which includes at least one picture, with or without accompanying sound, may be of various types and have various formats. Nor is there anything to prevent the user employing his mobile terminal in a degraded mode, i.e. without benefit of the extremely rich content of a picture included in an alarm message. In this case, for example in the event of an armed robbery in a bank in which the user is located, the user can activate his mobile terminal very discreetly in his pocket to send an alarm message to an emergency service, the alarm message being reduced to an audio message and the entirely black photo or video being unusable. In addition to a mode for sending an alarm message including a picture, the mobile terminal can also offer the user a mode for sending only audio, although this is much less beneficial than the main mode of use of the terminal in which an alarm message includes at least one picture.

In an embodiment meeting a requirement for alarm message authentication, appropriate measures are taken in the mobile terminal and/or in the server. An alarm message stored in the buffer memory area preferably includes an electronic signature of the user of the mobile terminal and is advantageously encrypted by the server.

In an advantageous embodiment, an alarm message stored in the buffer memory area includes at least one picture, an identifier of the mobile terminal that sent the alarm message, the place from which the mobile terminal sent the alarm message and the time at which the mobile terminal sent the alarm message. All the above elements are advantageously so disposed in the alarm message that the emergency service can process the alarm message as efficiently and as quickly as possible.

In one embodiment, the alarm message includes one or more photos, with or without sound accompaniment. This embodiment has the advantage of very clear pictures enabling accurate and reliable identification of objects or persons. In another embodiment, the alarm message includes a video, with or without sound. This embodiment has the advantage of indicating the context of a situation or the progress of an event better through a succession of pictures, even if they are of poorer definition than a photo, for example a succession of pictures showing violent or threatening behavior or the behavior of an injured person, enabling a more detailed assessment of the seriousness of his condition.

In the event of a problem or danger situation that is urgent or of circumstances making it difficult for the user to indicate his location, for example in the middle of a forest, if the user is not able to provide his location himself, for reasons of panic or because it is materially impossible, or if he can do so only under difficult conditions, the alarm system preferably locates the mobile terminal that sent an alarm message automatically and associates the location with the alarm message.

For legal reasons, which may vary and depend on regulations applicable in countries in which the alarm system may be used, certain alarm functions of the mobile terminal can be activated by the server and/or the emergency service, but not the user of the mobile terminal. This applies to the trace mode described later, for example. On the other hand, all the alarm functions of the mobile terminal can preferably be deactivated by the user of the mobile terminal, so that the user can always deactivate a function, even if this is authorized by regulations applicable in the country in which the alarm system is used. This applies to the trace mode described later, for example.

A preferred option is for the alarm system to offer the option of the mobile terminal operating in trace mode, i.e. periodically sending alarm messages to the server that the server stores in the buffer memory area. The buffer memory area may be consulted by other persons in the network of the user. For example, at certain times, an elderly person may set his mobile terminal to the trace mode so that one of his children can quickly alert a hospital, for example if he is feeling unwell. It may therefore be envisaged, in certain particular operating modes, that an alarm message stored in the buffer memory area by one user is sent to an emergency service by another user, the first user having implicitly agreed to this, for example by supplying a code for the second user to access the buffer memory area. On the other hand, an alarm message placed in the buffer memory area by one user can preferably not be deleted by another user.

To facilitate the processing of an alarm message that has actually been sent to an emergency service, the server is preferably able to set up a telephone connection between the emergency service and the mobile terminal at the request of the emergency service that has received an alarm message from a mobile terminal. In the event of multiple alarm messages relating to the same situation being sent, in order to advise the users that the situation is under control, the server is preferably able, at the request of an emergency service that has received an alarm message from a mobile terminal, to advise the mobile terminals of certain users that the emergency service is already processing the alarm message.

The emergency service will generally be an official emergency service. Preferred examples of emergency services are a police station, a fire station and a hospital. One or more of the emergency services could also be an unofficial emergency service, in particular a private detective agency, a nurse or a personal physician.

The emergency service to which an alarm message is sent may be selected in various ways, as to its type, for example police station, fire station or hospital, or as to its location, for example police station in the fourteenth precinct or police station in the fifteenth precinct. The emergency service to which the alarm message is sent is preferably the emergency service nearest the place from which the mobile terminal sent the alarm message.

In one embodiment, the user of the mobile terminal may select the type of emergency service to which the alarm message is sent, which has the advantage of enabling faster processing of the alarm message but may lead to transmission to an inappropriate emergency service, which could nevertheless in turn forward the alarm message to another emergency service better suited to processing the alarm message.

In another embodiment, the selection of the type of emergency service to which the alarm message is sent may be effected or corrected by the server, which has the advantage of being simpler for the user, even if the server is then more complex because it incorporates this selection function, unless it is the emergency service network that provides it, in which case the emergency service selection function is transferred to the emergency service network. The correction facility could consist, in the event of a manifest error by the user, either in redirecting the alarm message or in copying it to another emergency service at the same time as directing it to the emergency service specified by the user. The particular emergency service within a given type of emergency service to which the alarm message is sent is preferably selected by the server, for example on the basis of a geographical proximity criterion.

There is claimed:

1. An alarm system comprising:
a mobile terminal comprising a camera able to take at least one picture and a server interface able to send at least one alarm message including at least one picture;
at least one emergency service able to process an alarm message;
a server able to send an alarm message to an emergency service; and
characterized wherein it further comprises:
a buffer memory area external to said mobile terminal and able to store an alarm message;
said mobile terminal further comprising a user interface enabling said user of said mobile terminal to indicate to said server that an alarm message should be stored in said buffer memory area without being previously or simultaneously snet for processing to an emergency service.

2. An alarm system comprising:
a mobile terminal comprising:
a camera able to take at least one picture;
a server interface able to send at least one alarm message including at least one picture taken by said camera;
at least one emergency service able to process said alarm message;
a server able to send said alarm message to said emergency service or to one of said emergency services; characterized wherein it further comprises:
a buffer memory area external to said mobile terminal and able to store said alarm message or at least one of said alarm messages; said mobile terminal further comprising:
a user interface enabling said user of said mobile terminal to indicate to said server that an alarm message must be stored in said buffer memory area without being previously or simultaneously sent to said emergency service or to one of said emergency services so that said user can initiate or prevent processing by said emergency service or by one of said emergency services of an alarm message stored in said buffer memory area.

3. An alarm system according to claim 1, wherein said alarm message or messages stored in said buffer memory area cannot be deleted from said mobile terminal.

4. An alarm system according to claim 1, wherein said alarm message or messages stored in said buffer memory area cannot be modified from said mobile terminal.

5. An alarm system according to claim 1, wherein said alarm message or messages stored in said buffer memory area cannot be deleted or modified from said mobile terminal except using a secret code held by said user of said mobile terminal.

6. An alarm system according to claim 1, wherein said user interface of said mobile terminal enables said user of said mobile terminal to indicate to said server that an alarm message stored in said buffer memory area must be sent to an emergency service.

7. An alarm system according to claim 1, wherein said system comprises a time delay at the end of which said message or messages stored in said buffer memory area are sent to an emergency service unless said user issues an instruction to the contrary and said user interface of said mobile terminal enables said user of said mobile terminal to indicate to said server that an alarm message stored in said buffer memory area must not be sent to an emergency service.

8. An alarm system according to claim 7, wherein said time delay ranges from 6 hours to 48 hours.

9. An alarm system according to claim 1, wherein an alarm message stored in said buffer memory area may be deleted or modified from a telecommunication network element that is separate from said mobile terminal of said user and to which said user of said mobile terminal has access.

10. An alarm system according to claim 1, wherein an alarm message stored in said buffer memory area may be deleted by said user but not modified by said user.

11. An alarm system according to claim 1, wherein an alarm message stored in said buffer memory area includes an electronic signature of said user of said mobile terminal.

12. An alarm system according to claim 1, wherein an alarm message stored in said buffer memory area is encrypted by said server.

13. An alarm system according to claim 1, wherein an alarm message stored in said buffer memory area includes at least one picture, an identifier of said mobile terminal that sent said alarm message, the place from which said mobile terminal sent said alarm message and the time at which said mobile terminal sent said alarm message.

14. An alarm system according to claim 1 adapted to locate automatically said mobile terminal that sent an alarm message and associate said location with said alarm message.

15. An alarm system according to claim 1, wherein said alarm message includes one or more photos.

16. An alarm system according to claim 1, wherein said alarm message includes a video.

17. An alarm system according to claim 1, wherein activation of some alarm functions of said mobile terminal is possible by said server and/or by said emergency services but not by said user of said mobile terminal.

18. An alarm system according to claim 1, wherein deactivation of all said alarm functions of said mobile terminal is possible by said user of said mobile terminal.

19. An alarm system according to claim 1, offering the option of said mobile terminal operating in a trace mode, i.e. of periodically sending alarm messages to said server for said server to store said alarm messages in said buffer memory area.

20. An alarm system according to claim 1, wherein, at the request of an emergency service that has received an alarm message from a mobile terminal, said server is able to set up a telephone connection between said emergency service and said mobile terminal.

21. An alarm system according to claim 1, wherein, at the request of an emergency service that has received an alarm message from a mobile terminal, said server is able to advise said mobile terminal that said emergency service is processing said alarm message.

22. An alarm system according to claim 1, wherein said emergency service to which said alarm message is sent is the emergency service nearest the place from which said mobile terminal sent said alarm message.

23. An alarm system according to claim 1, wherein said emergency services include at least one police station and/or at least one fire station and/or at least one hospital.

24. An alarm system according to claim 1, wherein a type of emergency service to which said alarm message may be sent may be selected by said user of said mobile terminal.

25. An alarm system according to claim 1, wherein said selection of a type of emergency service to which said alarm message may be sent may be effected or corrected by said server.

26. An alarm system according to claim 1, wherein said server selects a particular emergency service from a given type of emergency service to which particular emergency service said alarm message may be sent.

27. An alarm mobile terminal comprising:
a camera able to take at least one picture;
a server interface able to send a server at least one alarm message including at least one picture taken by said camera;
a user interface enabling said user of said mobile terminal to indicate to a server that said alarm message must be stored in a buffer memory area external to said mobile terminal without previously or simultaneously being sent to an emergency service so that said user can initiate or prevent processing by an emergency service of an alarm message stored in said buffer memory area.

28. An alarm server for sending an emergency service an alarm message coming from a mobile terminal and including at least one picture, said server comprising:
a buffer memory area able to store said alarm message;
a processing device able, at the request of a user of said mobile terminal, to store in said buffer memory area an alarm message coming from a mobile terminal without previously or simultaneously sending it to an emergency service for processing.
